(19) United States
(12) Patent Application Publication
(10) Pub. No.: US 2010/0304191 A1
(43) Pub. Date: Dec. 2, 2010

(54) ENERGY STORAGE DEVICES HAVING CELLS ELECTRICALLY COUPLED IN SERIES AND IN PARALLEL

(75) Inventors: Jon K. West, Gainesville, FL (US); Julius Regalado, Gainesville, FL (US); Xin Zhou, Gainesville, FL (US); Daniel J. West, Gainesville, FL (US)

Correspondence Address: ROPES & GRAY LLP, PATENT DOCKETING 39/361, 1211 AVENUE OF THE AMERICAS, NEW YORK, NY, 10036-8704, US

(73) Assignee: G4 SYNERGETICS, INC., Roslyn, NY (US)

(21) Appl. No.: 12/766,225

(22) Filed: Apr. 23, 2010

Related U.S. Application Data
(60) Provisional application No. 61/172,448, filed on Apr. 24, 2009.
(60) Provisional application No. 61/224,725, filed on Jul. 10, 2009.

(51) Int. Cl. H01M 12/00; H01M 4/02; H01M 4/56

(52) U.S. Cl. 429/9; 429/209; 429/225

(57) ABSTRACT

A stacked energy storage device (ESD) has at least two cell segments arranged in a stack. Each cell segment may have a first electrode unit having a first active material electrode, a second electrode unit having a second active material electrode, and an electrolyte layer between the active material electrodes. The ESD includes at least two sub-stacks, where the elements of each respective sub-stack are electrically coupled in series with other elements of the sub-stack. The sub-stacks may be placed in a single stack, and the sub-stacks may be electrically coupled in parallel, in series, or both, with other sub-stacks to create an ESD with a particular voltage and current capacity. The entire stack may be contained by a single pair of end caps.

### CROSS-REFERENCE TO RELATED APPLICATION

This application claims the benefit of U.S. Provisional Application No. 61/172,448, filed Apr. 24, 2009, and U.S. Provisional Application No. 61/224,725, filed Jul. 10, 2009, both of which are hereby incorporated by reference herein in their entireties.

### FIELD OF THE INVENTION

This invention relates generally to energy storage devices (ESDs) and, more particularly, this invention relates to stacked ESDs having cells electrically coupled in series, in parallel, or both.

### BACKGROUND OF THE INVENTION

Design criteria for ESDs typically include power, energy, and service life, and may also include limitations for mass and/or volume. These design factors often depend on one another. For example, increasing the power of an ESD (e.g., by increasing the voltage and/or current capacity) may increase the mass and/or volume of the device.

A technique to increase the voltage (and thereby watt-hours) of a bi-polar ESD is to add additional bi-polar cells together in a taller stack. The current capacity of the stack, however, may be substantially the same as the capacity of a single cell. To increase the current capacity of the bi-polar ESD, several ESDs are typically wired in parallel. Each of these ESDs typically has its own pair of end caps for the containment of gas pressure and electrode expansion during cycling, which add to the weight of the entire system. However, the end caps typically do not add to the energy or power of the stack. This additional weight is generally called “parasitic” weight because no active materials are added with the increased weight of the respective cell stack.

The above technique unnecessarily limits increases in power and/or current capacity due to the substantial increases in parasitic weight and, in some cases, the volume of the system.

Accordingly, it would be desirable to provide an ESD with improved performance having cells electrically coupled in series and in parallel.

### SUMMARY OF THE INVENTION

In view of the foregoing, apparatus and methods are provided for stacked ESDs having cells electrically coupled in series and in parallel.

Any combination of parallel and series configurations may be assembled to create a particular voltage and current capacity. For example, at least two sub-stacks may be wired in series to increase the voltage of the total stack. The parasitic weight of this configuration of bi-polar cells may be relatively less than a typical arrangement (i.e., two or more ESDs electrically coupled in parallel with each having its own respective pair of end caps) because in some embodiments only one pair of end caps may be used.

In accordance with an embodiment, there is provided an ESD having a stack of a plurality of electrode units. The stack may include a first sub-stack of a plurality of bi-polar electrode units, a second sub-stack of a plurality of bi-polar electrode units collinear with the first stack, and a mono-polar electrode unit positioned between the first sub-stack and the second sub-stack. A first end cap may be at a first end of the stack of electrode units, and a second end cap may be at a second end of the stack of electrode units.

In accordance with an embodiment, there is provided an ESD having a stack of a plurality of electrode units along a stacking axis. The stack may include a mono-polar electrode unit having a first and second surface on opposite sides thereof, a first bi-polar electrode unit provided along the stacking axis opposite the first surface, and a second bi-polar electrode unit provided along the stacking axis opposite the second surface. The first and second bi-polar electrode units may be electrically coupled in parallel via the mono-polar electrode unit.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows a schematic cross-sectional view of an illustrative structure of a bi-polar electrode unit (BPU) according to an embodiment of the invention;

FIG. 2 shows a schematic cross-sectional view of an illustrative structure of a stack of BPUs of FIG. 1 according to an embodiment of the invention;

FIG. 3 shows a schematic circuit diagram of an illustrative bi-polar ESD having the stack of BPUs of FIG. 2 according to an embodiment of the invention;

FIG. 4 shows a schematic cross-sectional view of an illustrative structure of a stack of BPUs according to an embodiment of the invention;

FIG. 5 shows a schematic circuit diagram of the illustrative bi-polar ESD of FIG. 4 according to an embodiment of the invention;

FIG. 6 shows a perspective view of an illustrative stacked bi-polar ESD according to an embodiment of the invention;

FIG. 7 shows a partial cross-sectional view of the illustrative stacked bi-polar ESD of FIG. 6 according to an embodiment of the invention;

FIG. 8 shows an exploded view of the illustrative stacked bi-polar ESD of FIG. 6 according to an embodiment of the invention; and

FIG. 9 shows an exploded view of the illustrative stacked bi-polar ESD of FIG. 6 according to an embodiment of the invention.

### DETAILED DESCRIPTION OF THE INVENTION

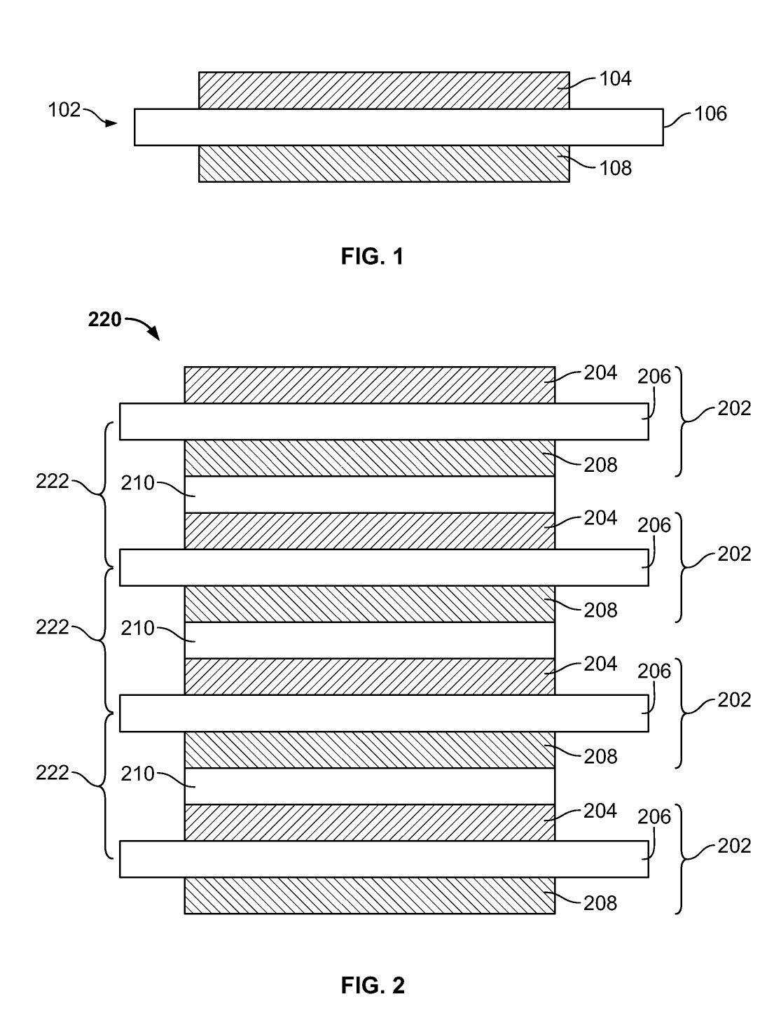

Apparatus and methods are provided for stacked energy storage devices (ESDs), and are described below with reference to FIGS. 1-9. The present invention relates to ESDs such as, for example, batteries, capacitors, or any other suitable electrochemical energy or power storage devices which may store and/or provide electrical energy or current. It will be understood that while the present invention is described herein in the context of a stacked bi-polar ESD electrically coupled in series and in parallel, the concepts discussed are applicable to any intercellular electrode configuration including, but not limited to, parallel plate, prismatic, folded, wound and/or bi-polar configurations, any other suitable configuration, or any combinations thereof.

ESDs with sealed cells in a stacked formation may include a series of stacked bi-polar electrode units (BPUs). Each of these BPUs is provided with a positive active material electrode layer and a negative active material electrode layer coated on opposite sides of a current collector. Any two BPUs may be stacked on top of one another with an electrolyte layer provided between the positive active material electrode layer of one of the BPUs and the negative active material electrode layer of the other one of the BPUs for electrically isolating the current collectors of those two BPUs. The current collectors of any two adjacent BPUs, along with the active material electrode layers and electrolyte therebetween, are a sealed single cell or cell segment. An ESD that includes a stack of such cells, each having a portion of a first BPU and a portion of a second BPU, shall be referred to herein as a “stacked bi-polar” ESD.

An ESD may include a number of cells that may be electrically coupled in series, in parallel, or both. A bi-polar ESD may eliminate the interconnecting current carrying components found on those ESDs that merely connect independent cells together in series. The bi-polar ESD's reduction of connecting materials (thereby reducing parasitic weight) may lower resistance and increase power, for example, and may make the ESD relatively smaller and lighter.

FIG. 1 shows an illustrative “flat plate” bi-polar electrode unit or BPU 102, in accordance with an embodiment of the present invention. Flat plate structures for use in stacked cell ESDs are discussed in more detail in Ogg et al. U.S. patent application Ser. No. 11/417,489, and Ogg et al. U.S. patent application Ser. No. 12/069,793, both of which are hereby incorporated by reference herein in their entireties. BPU 102 may include a positive active material electrode layer 104 that may be provided on a first side of an impermeable conductive substrate or current collector 106, and a negative active material electrode layer 108 that may be provided on the other side of impermeable conductive substrate 106.

It will be understood that the bi-polar electrode may have any suitable shape or geometry. For example, in some embodiments of the present invention, the “flat plate” BPUs may alternatively, or additionally, be “dish-shaped” electrodes. The dish-shaped electrodes may reduce pressures that may develop during operation of a bi-polar ESD. Dish-shaped and pressure equalizing electrodes are discussed in more detail in West et al. U.S. patent Application Ser. No. 12/258,854, which is hereby incorporated by reference herein in its entirety.

As shown in FIG. 2, for example, multiple BPUs 202 may be stacked substantially vertically into a stack 220, with an electrolyte layer 210 that may be provided between two adjacent BPUs 202, such that positive electrode layer 204 of one BPU 202 may be opposed to negative electrode layer 208 of an adjacent BPU 202 via electrolyte layer 210. Each electrolyte layer 210 may include a separator (not shown) that may hold an electrolyte therein. The separator may electrically separate the positive electrode layer 204 and negative electrode layer 208 adjacent thereto, while allowing ionic transfer between the electrode units.

With continued reference to the stacked state of BPUs 202 in FIG. 2, for example, the components included in positive electrode layer 204 and substrate 206 of a first BPU 202, the negative electrode layer 208 and substrate 206 of a second BPU 202 adjacent to the first BPU 202, and the electrolyte layer 210 between the first and second BPUs 202 shall be referred to herein as a single “cell” or “cell segment” 222. Each impermeable substrate 206 of each cell segment 222 may be shared by the applicable adjacent cell segment 222.

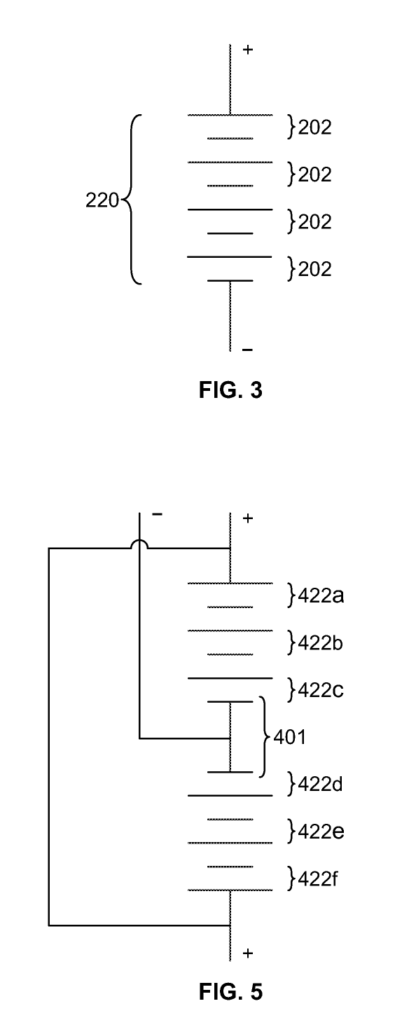

FIG. 3 shows a schematic circuit diagram of stack 220 of FIG. 2 according to an embodiment of the invention. A bi-polar ESD may include one or more BPUs 202 stacked and series-connected, as shown in FIG. 3, to provide a desired voltage.

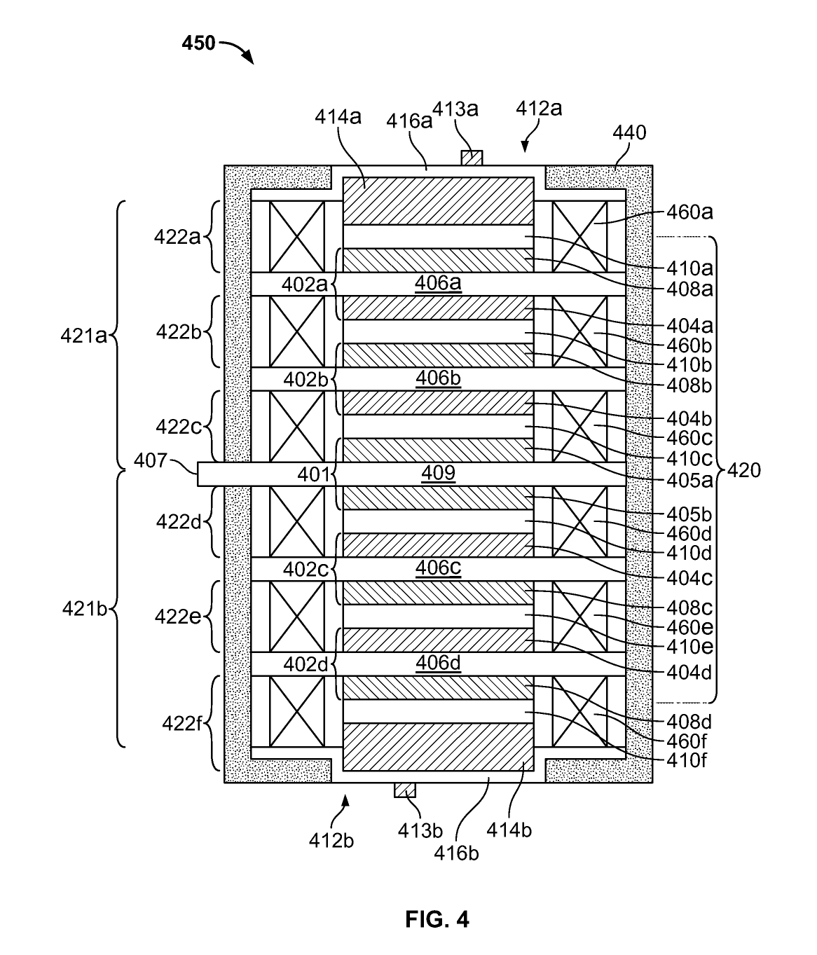

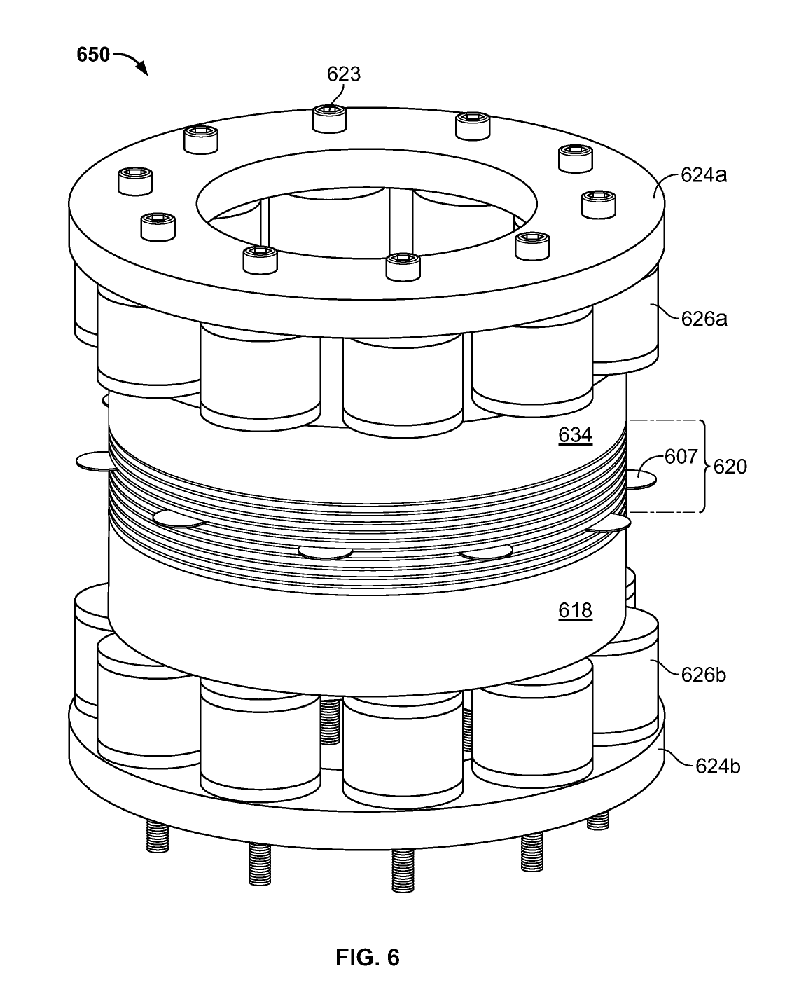

FIG. 4 shows a schematic cross-sectional view of a structure of a stack of BPUs according to an embodiment of the invention. As shown in FIG. 4, for example, independent cell stacks or sub-stacks 421a and 421b may be configured to be electrically coupled in parallel by having a “sub-terminal” mono-polar electrode unit located between the sub-stacks (see, e.g., sub-terminal MPU 401). Positive or negative sub-terminal mono-polar electrode units (MPUs) may be provided between independent cell stacks, or sub-stacks, in a bi-polar ESD. The sub-terminal MPUs may have active material electrode layers having the same polarity (i.e., positive or negative) provided on opposite sides of a substrate or current collector. Any suitable active material may be used with sub-terminal MPUs, and in some embodiments the active material electrode layers on either side of a sub-terminal MPU may be substantially the same active material or may be different active materials having the same polarity.

For example, FIG. 4 shows sub-terminal MPU 401 within stack 420 of bi-polar ESD 450. Sub-terminal MPU 401 may include a negative active material electrode layer 405a that may be provided on a first side of an impermeable conductive substrate or current collector 409, and a negative active material electrode layer 405b that may be provided on the other side of impermeable conductive substrate 409. Sub-terminal MPU 401 may be configured to electrically couple the cell segments of sub-stack 421a (see, e.g., cell segments 422a-422c) in parallel with the cell segments of sub-stack 421b (see, e.g., cell segments 422d-422f). For example, sub-terminal MPU 401 may be provided with a tab or flange 407. In some embodiments, flange 407 may provide, for example, an electrical connection to the bi-polar electrode unit or mono-polar unit corresponding to the respective substrate to which flange 407 is attached. As shown in FIG. 4, for example, flange 407 is attached to substrate 409 of sub-terminal MPU 401. However, it will be understood that tabs or flanges may be provided with the substrates of any suitable electrode units of the present invention, including, for example, the BPUs, sub-terminal MPUs, and terminal MPUs (see, e.g., flanges 607 of FIGS. 6-9).

Sub-terminal MPU 401 may act as an electrical separator, a mechanical separator, or both, between sub-stacks. In some embodiments, sub-terminal MPU 401 may have a different geometry than the bi-polar electrode units (see, e.g., BPUs 402a-d). For example, substrate 409 of sub-terminal MPU 401 may be relatively thicker or relatively thinner than substrate 406a of BPU 402a. Substrate 409 may be have variable thicknesses relative to substrate 406a, for example, because the electrodes having the same polarity on either side of substrate 409 (e.g., electrode layers 405a and 405b) may expand and/or contract differently than the electrodes on either side of substrate 406a that have opposite polarities (e.g., electrode layers 408a and 404a). For example, if MPU 401 has positive electrode layers on either side of substrate 409, one or both positive electrode layers may compress substrate 409. Furthermore, in some embodiments the sub-stacks of the ESD may have different base units and/or different chemistries (e.g., substack 421a may have a nickel-metal hydride ESD chemistry and substack 421b may utilize capacitors). In such embodiments, for example, the sub-stacks may expand and/or contract differently relative to one another, thereby exerting a net force on MPU 401. Thus, in some embodiments substrate 409 may be designed to be relatively thicker and more robust than substrates 406a-d. It will be understood, however, that in some embodiments, substrate 409 of sub-terminal MPU 401 may be substantially the same as the substrates of the BPUs (see, e.g., substrates 406a-d of BPUs 402a-d).

Sub-terminal MPU 401 may have any suitable inter-electrode spacing between the active materials of adjacent cell segments and may have any suitable gasket configuration. The inter-electrode spacing may depend on various ESD applications. For example, for relatively lower drain/high energy cells, it may be preferable to pack a relatively greater quantity of active materials and/or have a relatively thicker electrode matrix material to withstand the increased loading. For relatively higher power applications, it may be preferable to pack less material and/or close at a relatively higher force to decrease the inter-electrode spacing.

There may be many criteria for ESD design. These criteria typically specify power, energy, and service life, and may have limitations for mass and/or volume. These criteria may not be met by one ESD type alone. Therefore, in some embodiments, ESDs that combine energy storage types to achieve design requirements may be preferred. The bi-polar ESD of the present invention may be configured to accommodate multiple ESD types to achieve design requirements. For example, as discussed above, one sub-stack may have a nickel-metal hydride ESD chemistry and another sub-stack may utilize capacitors.

Bi-polar ESD 450 may include one or more fundamental base units. For example, suitable electrochemical ESD chemistries may include metal hydride, lithium, or any other suitable chemistry, or combinations thereof, and base units may include electrostatic capacitors. The multi-unit ESD may be configured for series or parallel power distribution, or both, and the device may include multiple types. In some embodiments, independent sub-stacks within an ESD may have different chemistries. For example, sub-stack 421a may include metal hydride elements and sub-stack 421b may include lithium-ion elements. In some embodiments, cells within the same sub-stack may have different chemistries from cell-to-cell or even within the same cell.

As discussed above, in some embodiments the ESD may include one or more sub-stacks having capacitors stacked therein. The capacitors may include an electrochemical double layer. The double layer component may refer to the accumulation of ions and electrons on the surface of the electrode materials (e.g., they may be contact surface area dependant). The effect may be relatively more electrostatic than electrochemical as ions and electrons may both be coupled on the surface of the electrode materials. This may be similar, for example, to electrostatic capacitors. The positive and negative electrode layers of the capacitor may have substantially the same composition so that there may be no or substantially no “natural” electrochemical potential when the ESD is assembled. The potential may arise when the ESD is charged, for example, by having electrons on one side and a substantially equal positive ionic charge that accumulates on the same surface. A similar event may occur on the negative electrode, for example, where negative ions may accumulate on the electrode surface caused by the depletion of electrons (e.g., “holes”) on the negative electrodes' electron depleted surface. It will be understood that, as discussed above in connection with the bi-polar units of the present invention, either side of the capacitor may be positive or negative.

When capacitors are electrically coupled in parallel with an ESD, the overall assembly may have a relatively higher working voltage. For example, metal hydride ESDs may be aqueous and may have an operating range of 1.5 volts. Capacitors having an electrochemical double layer may be formed of any suitable electrolyte and the operating ranges may be from 1.25 volts, or lower, to 20 volts, or higher, for example. The capacitors may also have a relatively low internal resistance, and may support ESDs having relatively high current draws. For example, for high-rate pulses, the capacitors may take most of the current draw before the ESD, which may buffer the ESD and which may increase the cycle life of the ESD.

Other capacitors may not have a double layer of ions and electrons. Rather, they may only operate via the electrostatic couple caused by the accumulation and depletion of electrons on the surface of the conductor (e.g., on metal foils). Once charged, the electrons may not propagate through the dielectric separator but may require close proximity to hold the electrostatic couple. Once the positive and negative terminals are coupled to bridge the circuit, electrons may flow back across the wires to re-equilibrate to substantially zero voltage. These capacitors may have a capacity that is relatively lower than capacitors having an electrochemical double layer.

The number of capacitor cells stacked in a sub-stack may depend on the voltage limits of the ESD. In some embodiments, the voltage of the capacitor sub-stack may be equal to or greater than the voltage of the ESD. Moreover, in some embodiments, for example, the voltage limit per cell of the capacitor may depend upon the electrolyte solvent breakdown voltage. Exemplary voltage limits may range from 1.2 volts (e.g., aqueous) to 20 volts (e.g., organic and siloxane) for liquid-based solvent devices. In some embodiments, the ESD of the present invention may incorporate capacitors in a sub-stack having substantially the same solvent as that used in another sub-stack having, for example, metal hydride chemistry, where the cells may be configured to have a 1.5 volt limit.

With continued reference to FIG. 4, there are two independent three-cell stacks (i.e., sub-stacks 421a and 421b) with sub-terminal MPU 401 thus centrally located in stack 420 between sub-stacks 421a and 421b. It will be understood, however, that sub-terminal MPU 401 may provided at any suitable location within stack 420. For example, independent cell stacks (see, e.g., sub-stack 421a) may have any suitable number of cells (e.g., to increase the voltage of a particular stack or sub-stack) so that sub-terminal MPU 401 may be located in any suitable location in a stack that is between the independent sub-stacks (e.g., sub-stacks 421a and 421b). It will also be understood that ESD 450 may have any suitable number of independent cell stacks or sub-stacks, with an appropriate number of sub-terminal MPUs provided therebetween. In some embodiments, for example, multiple sub-stacks may be incorporated to increase the voltage and/or current capacity of the ESD.

As shown in FIG. 4, for example, positive or negative terminals, or terminal mono-polar units (MPUs), may be provided along with stack 420 of one or more BPUs 402a-d and sub-terminal MPU 401 to constitute a stacked bi-polar ESD 450 in accordance with an embodiment of the invention. In the arrangement shown in FIG. 4, for example, the polarity of the terminal MPUs may be opposite the polarity of sub-terminal MPU 401. A positive terminal MPU 412b, that may include a positive active material electrode layer 414b provided on one side of an impermeable conductive substrate 416b, may be positioned at a first end of stack 420 with an electrolyte layer provided (i.e., electrolyte layer 410f), such that positive electrode layer 414b of positive terminal MPU 412b may be opposed to a negative electrode layer (i.e., layer 408d) of the BPU (i.e., BPU 402d) at that first end of stack 420 via the electrolyte layer 410f. A positive terminal MPU 412a, that may include a positive active material electrode layer 414a provided on one side of an impermeable conductive substrate 416a, may be positioned at the second end of stack 420 with an electrolyte layer provided (i.e., electrolyte layer 410a), such that positive electrode layer 414a of positive terminal MPU 412a may be opposed to a negative electrode layer (i.e., layer 408a) of the BPU (i.e., BPU 402a) at that second end of stack 420 via the electrolyte layer 410a. Terminal MPUs 412a and 412b may be provided with corresponding positive electrode leads 413a and 413b, respectively.

The substrate and electrode layer of each terminal MPU or sub-terminal MPU may form a cell segment with the substrate and electrode layer of its adjacent BPU, and the electrolyte layer therebetween, as shown in FIG. 4, for example (see, e.g., cell segments 422a/422f and cell segments 422c/422d). The number of stacked BPUs in stack 420 may be one or more, and may be appropriately determined in order to correspond, for example, to a desired voltage for ESD 450. The number of stacked BPUs in a sub-stack (e.g., sub-stacks 421a and 421b) may be one or more, and may be appropriately determined in order to correspond, for example, to a desired voltage for ESD 450. Each BPU may provide any desired potential, such that a desired voltage for ESD 450 may be achieved by effectively adding the potentials provided by each component BPU. It will be understood that each BPU need not provide identical potentials.

In one suitable embodiment, bi-polar ESD 450 may be structured so that BPU stack 420 and its respective positive terminal MPUs 412a and 412b may be at least partially encapsulated (e.g., hermetically sealed) into an ESD case or wrapper 440 under reduced pressure. Terminal MPU conductive substrates 416a and 416b (or at least their respective electrode leads 413a and 413b) may be drawn out of ESD case or wrapper 440, so as to mitigate impacts from the exterior upon usage and to prevent environmental degradation, for example.

In order to prevent electrolyte of a first cell segment (see, e.g., electrolyte layer 410a of cell segment 422a) from combining with the electrolyte of another cell segment (see, e.g., electrolyte layer 410b of cell segment 422b), gaskets or sealants may be stacked with the electrolyte layers between adjacent electrode units to seal electrolyte within its particular cell segment. A gasket or sealant may be any suitable compressible or incompressible solid or viscous material, any other suitable material, or combinations thereof, for example, that may be provided with adjacent electrode units of a particular cell to seal electrolyte therebetween. In one suitable arrangement, as shown in FIG. 4, for example, the bi-polar ESD of the invention may include gaskets or seals 460a-f that may be positioned as a barrier about electrolyte layers 410a-f and active material electrode layers 404a-d/414a-b and 408a-d/405a-b of each cell segment 422a-e. The gasket or sealant may be continuous and closed and may seal electrolyte between the gasket and the adjacent electrode units of that cell (i.e., the BPUs or the BPU and sub-terminal MPU/terminal MPU adjacent to that gasket or seal). The gasket or sealant may provide appropriate spacing between the adjacent electrode units of that cell, for example. In some embodiments a dynamic flexible seal or gasket may be provided. In this application the gasket may mechanically adjust dimensions while maintaining a substantially sealed contact with the adjoining surfaces. For example, the dynamic flexible seal or gasket may be configured to deform in a preferred direction or preferred directions. Dynamic flexible seals and gaskets are discussed in more detail in West et al. U.S. Patent Application No. 12/694,638, which is hereby incorporated by reference herein in its entirety.

In sealing the cell segments of stacked bi-polar ESD 450 to prevent electrolyte of a first cell segment (see, e.g., electrolyte layer 410a of cell segment 422a) from combining with the electrolyte of another cell segment (see, e.g., electrolyte layer 410b of cell segment 422b), cell segments may produce a pressure differential between adjacent cells (e.g., cells 422a/422b) as the cells are charged and discharged. Equalization valves may be provided to substantially decrease the pressure differences thus arising. Equalization valves may operate as a semi-permeable membrane or rupture disk, either mechanically or chemically, to allow the transfer of a gas and to substantially prevent the transfer of electrolyte. An ESD may have BPUs, sub-terminal MPUs, and terminal MPUs having any combination of equalization valves. Pressure equalization valves are discussed in more detail in West et. al U.S. Patent Application No. 12/258,854, which is hereby incorporated by reference herein in its entirety.

FIG. 5 shows a schematic circuit diagram of the bi-polar ESD of FIG. 4 according to an embodiment of the invention. For example, the cell segments within each respective independent cell stacks or sub-stack may be electrically coupled in series with the other cells of the sub-stack (see, e.g., the series-connection of FIGS. 2 and 3). The two sub-stacks may then be electrically coupled in parallel to one another via a sub-terminal MPU (see, e.g., sub-terminal MPU 401 of FIG. 4). This arrangement may allow, for example, multiple cells to be electrically coupled in series and/or in parallel in a stack while using only one pair of end caps (see, e.g., end caps 618 and 634 of FIGS. 6-8). This may reduce the parasitic weight of the ESD compared to, for example, ESDs electrically coupled in series and in parallel using multiple end caps.

As shown in FIG. 5, for example, the sub-stacks may be electrically coupled in parallel via one or more wires that may be attached to sub-terminal MPU 401. The wires may be attached to one or more flanges of the substrate of sub-terminal MPU 401 (see, e.g., flange 407 of FIG. 4 and flanges 607 of FIGS. 6-9). It will be understood that utilizing a wire is only one of many suitable approaches for making the parallel connections. For example, in some embodiments a sub-terminal MPU may be bonded directly to a conductive outside container (see, e.g., ESD wrapper 440 of FIG. 4) and no wires may be needed. In this embodiment, for example, each end of the ESD may have both a positive post or electrode lead (see, e.g., leads 413a and 413b) and a negative casing (not shown) in contact with the conductive outside container for providing a negative electrical connection. Any other suitable approach for electrically coupling the sub-stacks in parallel via sub-terminal MPU 401 may be used, or any combinations thereof. For example, in some embodiments both wires and a sub-terminal MPU bonded directly to a conductive outside container may be used.

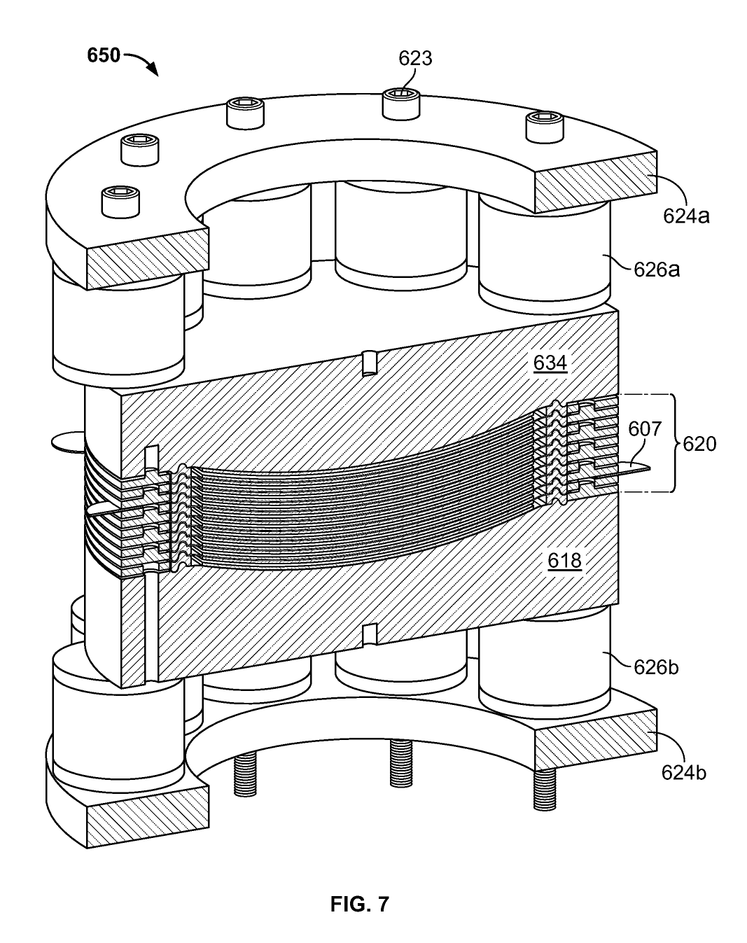

FIGS. 6 and 7 show a perspective view and a partial cross-sectional view, respectively, of a stacked bi-polar ESD according to an embodiment of the present invention. Stacked bi-polar ESD 650 may include compression bolts 623, alignment rings 624a and 624b, mechanical springs 626a and 626b, stack 620 (including substrate flanges 607), and rigid end caps 634 and 618 provided at either end of stack 620. Alignment rings may be provided at either end of stacked bi-polar ESD 650. For example, alignment ring 624a and alignment ring 624b may be provided at opposing ends of ESD 650. Mechanical springs may be provided between alignment rings 624a/624b and rigid end caps 634/618. For example, mechanical springs 626a may be provided between alignment ring 624a and rigid end cap 634 and mechanical springs 626b may be provided between alignment ring 624b and rigid end cap 618. Mechanical springs 626a and 626b may be configured to deflect in response to forces generated during operation and cycling of ESD 650. In some embodiments, deflection of springs 626a and 626b may be directly proportional to the applied load.

Rigid end caps 634 and 618 may be shaped to substantially conform to the shape of the electrodes and/or substrates of bi-polar ESD 650 (see, e.g., BPUs 402a-d of FIG. 4). For example, end caps 634 and 618 may conform to the “flat plate,” “dish-shaped,” or any other shape, or combinations thereof, of the electrodes and/or substrates of ESD 350.

In some embodiments, substrate flanges 607 may be provided about bi-polar ESD 650 and may extrude radially outwardly from stack 620. Flange 607 may provide, for example, an electrical connection to a bi-polar electrode unit or mono-polar unit corresponding to the respective impermeable conductive substrate to which flange 607 is attached (see, e.g., flange 407 of sub-terminal MPU 401 of FIG. 4). Although flange 607 of FIG. 6 is shaped as a “tongue depressor,” it may be any other suitable shape, and of any other suitable size, configured to extend radially outwardly from stack 620. For example, the cross-sectional area of flange 607 may be substantially rectangular, triangular, circular or elliptical, hexagonal, or any other desired shape or combination thereof, and may be configured to electrically couple with a particular connector or connectors.

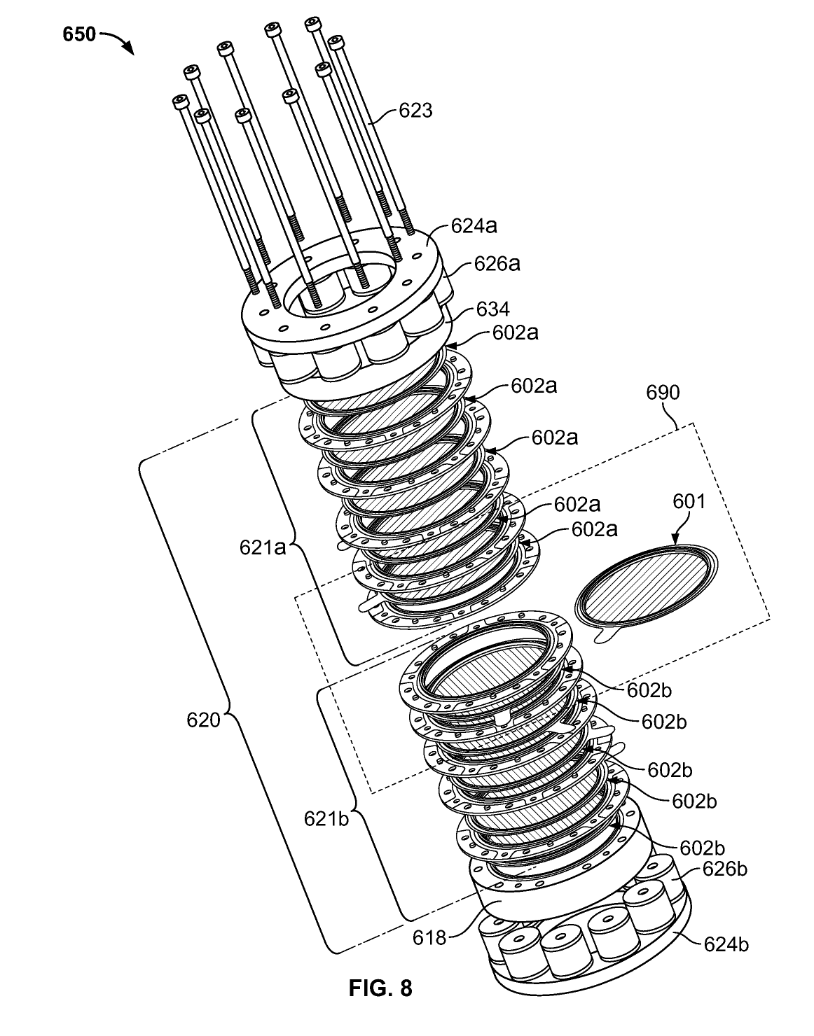

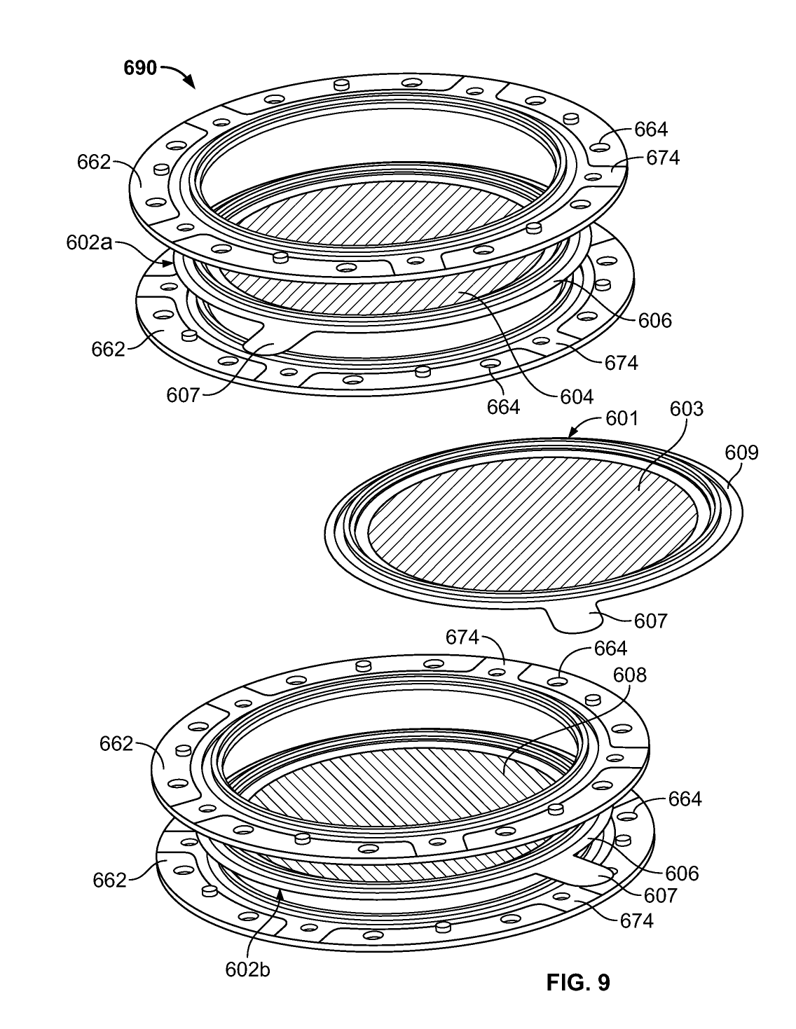

FIGS. 8 and 9 show an exploded view of the stacked bi-polar ESD of FIG. 6 according to an embodiment of the invention. As shown in FIG. 8, for example, stack 620 may include sub-stacks 621a and 621b. Sub-stack 621a may include a stack of five BPUs 602a. Similarly, sub-stack 621b may include a stack of five BPUs 602b. It will be understood, however, that any suitable number of cell segments and/or bi-polar units may be provided in sub-stacks 621a and 621b to correspond, for example, to a desired voltage and/or current capacity for ESD 650. A sub-terminal MPU 601 may be provided between sub-stacks 621a and 621b thereby separating the series electrical connections of the BPUs of sub-stack 621a from the series electrical connections of the BPUs of sub-stack 621b. Sub-terminal MPU 601 may be configured to couple the BPUs of sub-stack 621a in parallel with the BPUs of sub-stack 621b, for example, via the plurality of flanges 607 attached to each respective substrate (see, e.g., flanges 607 of FIG. 9). As discussed above in connection with FIG. 5, it will be understood that utilizing flanges (e.g., flanges 607) is only one of many suitable approaches for making the parallel connections between sub-stacks of an ESD.

Referring to FIG. 9 (represented as region 690 of FIG. 8), sub-terminal MPU 601 may have active material electrode layers having the same polarity (i.e., positive or negative) provided on opposite sides of a substrate or current collector. As shown in FIG. 9, for example, sub-terminal MPU 601 may include a positive active material electrode layer 603 that may be provided on a first side of an impermeable conductive substrate or current collector 609. A second positive active material electrode layer may be provided on the other side of impermeable conductive substrate 609 (not shown).

BPU 602a may include a positive active material electrode layer 604 that may be provided on a first side of an impermeable conductive substrate or current collector 606, and a negative active material electrode layer 608 (not shown) that may be provided on the other side of impermeable conductive substrate 606. BPU 602b may include a negative active material electrode layer 608 that may be provided on a first side of impermeable conductive substrate or current collector 606, and a positive active material electrode layer 604 (not shown) that may be provided on the other side of impermeable conductive substrate 606. The substrates 606 may further include substrate flanges 607 extending radially outwardly therefrom.

By separating the sub-stacks of ESD 650, sub-terminal MPU 601 may in effect operate as an end cap for a particular sub-stack. As shown in FIGS. 6-8, for example, ESD 650 has at least two sub-stacks electrically coupled in parallel and arranged in a single stack 620 having only one pair of end caps 618 and 634.

With continuing reference to FIG. 9, hard stops 662 may be provided between each respective electrode unit (e.g., BPUs 602a and 602b and sub-terminal MPU 601). Hard stops 662 may substantially encircle the contents of each respective cell segment. Furthermore, each hard stop 662 may have a shelf on which a substrate (e.g., substrates 606 and 609) may be securely positioned.

A set of bolt holes 664 for a plurality of compression bolts (see, e.g., compression bolts 623 of FIG. 6), or any other suitable rigid fasteners, may be provided along the outer rim of hard stops 662. Bolt holes 664 may align an entire stack of electrode units (see, e.g., BPUs 402a-d, sub-terminal MPU 401, and terminal MPUs 412a and 412b) during assembly, for example, and may provide stability during operation. Bolt holes 664 may be sized to accommodate a particular compression bolt or any other suitable rigid fastener. While bolt holes 664 are shown as circular, they may also be substantially rectangular, triangular, elliptical, hexagonal, or any other desired shape or combination thereof.

Hard stops 662 may also include a plurality of substrate shelves 674 that may align with substrate flanges 607. Substrate shelves 674 may allow a flange to protrude radially outwardly from stack 620 through hard stop 662 to allow the flange, for example, to electrically couple to a lead. Although hard stops 662 are shown as each having five substrate shelves 674, any suitable number of shelves 674 may be provided and that number may depend on the particular electrode units used in the ESD. Furthermore, the hard stops 662 may be configured to substantially set the inter-electrode spacing of the ESD. Various techniques for adjusting the inter-electrode spacing of ESDs are described in more detail in West et al. U.S. patent application Ser. No. 12/694,638, which is hereby incorporated by reference herein in its entirety.

The substrates used to form the electrode units of the invention (e.g., substrates 406a-d, 409, 416a, and 416b) may be formed of any suitable conductive and impermeable or substantially impermeable material, including, but not limited to, a non-perforated metal foil, aluminum foil, stainless steel foil, cladding material including nickel and aluminum, cladding material including copper and aluminum, nickel plated steel, nickel plated copper, nickel plated aluminum, gold, silver, any other suitable material, or combinations thereof, for example. Each substrate may be made of two or more sheets of metal foils adhered to one another, in certain embodiments. The substrate of each BPU may typically be between 0.025 and 5 millimeters thick, while the substrate of each MPU may be between 0.025 and 10 millimeters thick and act as terminals or sub-terminals to the ESD, for example. Metalized foam, for example, may be combined with any suitable substrate material in a flat metal film or foil, for example, such that resistance between active materials of a cell segment may be reduced by expanding the conductive matrix throughout the electrode.

In some embodiments, substrate 409 of sub-terminal MPU 401 may be formed of any suitable non-conductive and impermeable or substantially impermeable material, including, but not limited to, various plastics, phenolics, ceramics, epoxy performs in a binary composite, glass-ceramics, multiple dimensional woven fiber composites, any other suitable material, or combinations thereof, for example.

The positive electrode layers provided on these substrates to form the electrode units of the invention (e.g., positive electrode layers 404a-d, 414a, and 414b) may be formed of any suitable active material, including, but not limited to, nickel hydroxide (Ni(OH)₂), zinc (Zn), any other suitable material, or combinations thereof, for example. The positive active material may be sintered and impregnated, coated with an aqueous binder and pressed, coated with an organic binder and pressed, or contained by any other suitable technique for containing the positive active material with other supporting chemicals in a conductive matrix. The positive electrode layer of the electrode unit may have particles, including, but not limited to, metal hydride (MH), palladium (Pd), silver (Ag), any other suitable material, or combinations thereof, infused in its matrix to reduce swelling, for example. This may increase cycle life, improve recombination, and reduce pressure within the cell segment, for example. These particles, such as MH, may also be in a bonding of the active material paste, such as Ni(OH)₂, to improve the electrical conductivity within the electrode and to support recombination.

The negative electrode layers provided on these substrates to form the electrode units of the invention (e.g., negative electrode layers 408a-d, 405a, and 405b) may be formed of any suitable active material, including, but not limited to, MH, Cd, Mn, Ag, any other suitable material, or combinations thereof, for example. The negative active material may be sintered, coated with an aqueous binder and pressed, coated with an organic binder and pressed, or contained by any other suitable technique for containing the negative active material with other supporting chemicals in a conductive matrix, for example. The negative electrode side may have chemicals including, but not limited to, Ni, Zn, Al, any other suitable material, or combinations thereof, infused within the negative electrode material matrix to stabilize the structure, reduce oxidation, and extend cycle life, for example.

Various suitable binders, including, but not limited to, organic carboxymethylcellulose (CMC) binder, Creyton rubber, PTFE (Teflon), any other suitable material, or combinations thereof, for example, may be mixed with the active material layers to hold the layers to their substrates. Ultra-still binders, such as 200 ppi metal foam, may also be used with the stacked ESD constructions of the invention.

The separator of each electrolyte layer of the ESD of the invention may be formed of any suitable material that electrically isolates its two adjacent electrode units while allowing ionic transfer between those electrode units. The separator may contain cellulose super absorbers to improve filling and act as an electrolyte reservoir to increase cycle life, wherein the separator may be made of a polyabsorb diaper material, for example. The separator may, thereby, release previously absorbed electrolyte when charge is applied to the ESD. In certain embodiments, the separator may be of a lower density and thicker than normal cells so that the inter-electrode spacing (IES) may start higher than normal and be continually reduced to maintain the capacity (or C-rate) of the ESD over its life as well as to extend the life of the ESD.

The separator may be a relatively thin material bonded to the surface of the active material on the electrode units to reduce shorting and improve recombination. This separator material may be sprayed on, coated on, pressed on, or combinations thereof, for example. The separator may have a recombination agent attached thereto, in certain embodiments. This agent may be infused within the structure of the separator (e.g., this may be done by physically trapping the agent in a wet process using a polyvinyl alcohol (PVA or PVOH) to bind the agent to the separator fibers, or the agent may be put therein by electro-deposition), or it may be layered on the surface by vapor deposition, for example. The separator may be made of any suitable material or agent that effectively supports recombination, including, but not limited to, Pb, Ag, any other suitable material, or combinations thereof, for example. While the separator may present a resistance if the substrates of a cell move toward each other, a separator may not be provided in certain embodiments of the invention that may utilize substrates stiff enough not to deflect.

The electrolyte of each electrolyte layer of the ESD of the invention may be formed of any suitable chemical compound that may ionize when dissolved or molten to produce an electrically conductive medium. The electrolyte may be a standard electrolyte of any suitable chemical, including, but not limited to, NiMH, for example. The electrolyte may contain additional chemicals, including, but not limited to, lithium hydroxide (LiOH), sodium hydroxide (NaOH), calcium hydroxide (CaOH), potassium hydroxide (KOH), any other suitable material, or combinations thereof, for example. The electrolyte may also contain additives to improve recombination, including, but not limited to, Ag(OH)₂, for example. The electrolyte may also contain rubidium hydroxide (RbOH), for example, to improve low temperature performance. In some embodiments of the invention, the electrolyte may be frozen within the separator and then thawed after the ESD is completely assembled. This may allow for particularly viscous electrolytes to be inserted into the electrode unit stack of the ESD before the gaskets have formed substantially fluid tight seals with the electrode units adjacent thereto.

The seals or gaskets of the ESD of the invention (e.g., gaskets 460a-f) may be formed of any suitable material or combination of materials that may effectively seal an electrolyte within the space defined by the gasket and the electrode units adjacent thereto. In certain embodiments, the gasket may be formed from a solid seal barrier or loop, or multiple loop portions capable of forming a solid seal loop, that may be made of any suitable nonconductive material, including, but not limited to, nylon, polypropylene, cell gard, rubber, PVOH, any other suitable material, or combinations thereof, for example. A gasket formed from a solid seal barrier may contact a portion of an adjacent electrode to create a seal therebetween.

Alternatively or additionally, the gasket may be formed from any suitable viscous material or paste, including, but not limited to, epoxy, brea tar, electrolyte (e.g., KOH) impervious glue, compressible adhesives (e.g., two-part polymers, such as Loctite° brand adhesives made available by the Henkel Corporation, that may be formed from silicon, acrylic, and/or fiber reinforced plastics (FRPs) and that may be impervious to electrolytes), any other suitable material, or combinations thereof, for example. A gasket formed from a viscous material may contact a portion of an adjacent electrode to create a seal therebetween. In some embodiments, a gasket may be formed by a combination of a solid seal loop and a viscous material, such that the viscous material may improve sealing between the solid seal loop and an adjacent electrode unit. Alternatively or additionally, an electrode unit itself may be treated with viscous material before a solid seal loop, a solid seal loop treated with additional viscous material, an adjacent electrode unit, or an adjacent electrode unit treated with additional viscous material, is sealed thereto, for example.

Moreover, in certain embodiments, a gasket or sealant between adjacent electrode units may be provided with one or more weak points that may allow certain types of fluids (i.e., certain liquids or gasses) to escape therethrough (e.g., if the internal pressures in the cell segment defined by that gasket increases past a certain threshold). Once a certain amount of fluid escapes or the internal pressure decreases, the weak point may reseal. A gasket formed at least partially by certain types of suitable viscous material or paste, such as brai, may be configured or prepared to allow certain fluids to pass therethrough and configured or prepared to prevent other certain fluids to pass therethrough. Such a gasket may prevent any electrolyte from being shared between two cell segments that may cause the voltage and energy of the ESD to fade (i.e., discharge) quickly to zero.

As mentioned above, one benefit of utilizing ESDs designed with sealed cells in a stacked formation (e.g., bi-polar ESD 450) may be an increased discharge rate of the ESD. This increased discharge rate may allow for the use of certain less-corrosive electrolytes (e.g., by removing or reducing the whetting, conductivity enhancing, and/or chemically reactive component or components of the electrolyte) that otherwise might not be feasible in prismatic or wound ESD designs. This leeway that may be provided by the stacked ESD design to use less-corrosive electrolytes may allow for certain epoxies (e.g., J-B Weld epoxy) to be utilized when forming a seal with gaskets that may otherwise be corroded by more-corrosive electrolytes.

The hard stops of the ESD of the invention (see, e.g., hard stops 662 of FIG. 9) may be formed of any suitable material including, but not limited to, various polymers (e.g., polyethylene, polypropylene), ceramics (e.g., alumina, silica), any other suitable mechanically durable and/or chemically inert material, or combinations thereof. The hard stop material or materials may be selected, for example, to withstand various ESD chemistries that may be used.

The mechanical springs of the invention (see, e.g., mechanical springs 626a and 626b of FIGS. 6-8) may be any suitable spring that may deflect or deform in response to an applied load. For example, the mechanical springs may be designed to deflect in response to particular loads or a particular load threshold. Any suitable type of spring may be used, including compressible springs, such as open-coiled helical springs, variable pitch springs, and torsion springs; or flat springs, or any other suitable spring, or combinations thereof. The spring itself may be any suitable material, including, but not limited to, high carbon steels, alloy steels, stainless steel, copper alloys, any other suitable inflexible or flexible material, or combinations thereof.

The end caps of the present invention (see, e.g., end caps 618 and 636 of FIGS. 6-8) may be formed of any suitable material or combination of materials that may be conductive or non-conductive, including, but not limited to various metals (e.g., steel, aluminum, and copper alloys), polymers, ceramics, any other suitable conductive or non-conductive material, or combinations thereof.

A case or wrapper of the ESD of the invention (see, e.g., wrapper 440 of FIG. 4) may be provided, and may be formed of any suitable nonconductive material that may seal to the terminal electrode units (e.g., terminal MPUs 412a and 412b) for exposing their conductive substrates (e.g., substrates 416a and 416b) or their associated leads (e.g., leads 413a and 413b). The wrapper may also be formed to create, support, and/or maintain the seals between the gaskets and the electrode units adjacent thereto for isolating the electrolytes within their respective cell segments. The wrapper may create and/or maintain the support needed for these seals such that the seals may resist expansion of the ESD as the internal pressures in the cell segments increase. The wrapper may be made of any suitable material, including, but not limited to, nylon, any other polymer or elastic material, including reinforced composites, nitrile rubber, or polysulfone, or shrink wrap material, or any rigid material, such as enamel coated steel or any other metal, or any insulating material, any other suitable material, or combinations thereof, for example. In certain embodiments, the wrapper may be formed by an exoskeleton of tension clips, for example, that may maintain continuous pressure on the seals of the stacked cells. A non-conductive barrier may be provided between the stack and wrapper to prevent the ESD from shorting.

With continued reference to FIG. 4, for example, bi-polar ESD 450 of the invention may include a plurality of cell segments (e.g., cell segments 422a-f) formed by terminal MPUs 412a and 412b, and the sub-stacks of one or more BPUs 402a-d having sub-terminal MPU 401 therebetween. In accordance with an embodiment of the invention, the thicknesses and materials of each one of the substrates (e.g., substrates 406a-d, 409, 416a, and 416b), the electrode layers (e.g., positive layers 404a-d, 414a, and 414b, and negative layers 408a-d, 405a, and 405b), the electrolyte layers (e.g., layers 410a-f), and the gaskets (e.g., gaskets 460a-f) may differ from one another, not only from cell segment to cell segment, but also within a particular cell segment. This variation of geometries and chemistries, not only at the stack level, but also at the individual cell level, may create ESDs with various benefits and performance characteristics.

Additionally, the materials and geometries of the substrates, electrode layers, electrolyte layers, and gaskets may vary along the height of the stack from cell segment to cell segment. With further reference to FIG. 4, for example, the electrolyte used in each of the electrolyte layers 410a-f of ESD 450 may vary based upon how close its respective cell segment 422a-f is to the middle of the stack or sub-stack of cell segments. For example, with reference to sub-stack 421a, innermost cell segment 422b (i.e., the middle cell segment of the three (3) segments) may include an electrolyte layer (i.e., electrolyte layer 410b) that is formed of a first electrolyte, while outermost cell segments 422a and 422c (i.e., the outermost cell segments in sub-stack 421a) may include electrolyte layers (i.e., electrolyte layers 410a and 410b, respectively) that are each formed of a second electrolyte. By using higher conductivity electrolytes in the internal sub-stacks, the resistance may be lower such that the heat generated may be less. This may provide thermal control to the ESD by design instead of by external cooling techniques.

As another example, the active materials used as electrode layers in each of the cell segments of ESD 450 may also vary based upon how close its respective cell segment 422a-f is to the middle of the stack or sub-stack of cell segments. For example, with reference to sub-stack 421a, innermost cell segment 422b may include electrode layers (i.e., layers 404a and 408b) formed of a first type of active materials having a first temperature and/or rate performance, while outermost cell segments 422a and 422c may include electrode layers (i.e., layers 414a/408a and layers 404b/405a) formed of a second type of active materials having a second temperature and/or rate performance. As an example, an ESD stack may be thermally managed by constructing the innermost cell segments with electrodes of nickel cadmium, which may better absorb heat, while the outermost cell segments may be provided with electrodes of nickel metal hydride, which may need to be cooler, for example. Alternatively, the chemistries or geometries of the ESD may be asymmetric, where the cell segments at one end of the stack may be made of a first active material and a first height, while the cell segments at the other end of the stack may be of a second active material and a second height.

Moreover, the geometries of each of the cell segments of ESD 450 may also vary along the stack of cell segments. Besides varying the distance between active materials within a particular cell segment, certain cell segments 422a-f may have a first distance between the active materials of those segments, while other cell segments may have a second distance between the active materials of those segments. In any event, the cell segments or portions thereof having smaller distances between active material electrode layers may have higher power, for example, while the cell segments or portions thereof having larger distances between active material electrode layers may have more room for dendrite growth, longer cycle life, and/or more electrolyte reserve, for example. These portions with larger distances between active material electrode layers may regulate the charge acceptance of the ESD to ensure that the portions with smaller distances between active material electrode layers may charge first, for example.

In an embodiment, the geometries of the electrode layers (e.g., positive layers 404a-d, 414a, and 414b, and negative layers 408a-d, 405a, and 405b of FIG. 4) of ESD 450 may vary along the radial length of the substrates (e.g., substrates 406a-d, 409, 416a, and 416b). With respect to FIG. 4, the electrode layers are of uniform thickness and are symmetric about the electrode shape. In an embodiment, the electrode layers may be non-uniform. For example, the positive active material electrode layer and negative active material electrode layer thicknesses may vary with radial position on the surface of the conductive substrate. Non-uniform electrode layers are discussed in more detail in West et al. U.S. patent application Ser. No. 12/258,854, which is hereby incorporated by reference herein in its entirety.

Although each of the above described and illustrated embodiments of a stacked ESD show a cell segment including a gasket sealed to each of a first and second electrode unit for sealing an electrolyte therein, it should be noted that each electrode unit of a cell segment may be sealed to its own gasket, and the gaskets of two adjacent electrodes may then be sealed to each other for creating the sealed cell segment.

In certain embodiments, a gasket may be injection molded to an electrode unit or another gasket such that they may be fused together to create a seal. In certain embodiments, a gasket may be ultrasonically welded to an electrode unit or another gasket such that they may together form a seal. In other embodiments, a gasket may be thermally fused to an electrode unit or another gasket, or through heat flow, whereby a gasket or electrode unit may be heated to melt into an other gasket or electrode unit. Moreover, in certain embodiments, instead of or in addition to creating groove shaped portions in surfaces of gaskets and/or electrode units to create a seal, a gasket and/or electrode unit may be perforated or have one or more holes running through one or more portions thereof. Alternatively, a hole or passageway or perforation may be provided through a portion of a gasket such that a portion of an electrode unit (e.g., a substrate) may mold to and through the gasket. In yet other embodiments, holes may be made through both the gasket and electrode unit, such that each of the gasket and electrode unit may mold to and through the other of the gasket and electrode unit, for example.

Although each of the above described and illustrated embodiments of the stacked ESD show an ESD formed by stacking substrates having substantially round cross-sections into a cylindrical ESD, it should be noted that any of a wide variety of shapes may be utilized to form the substrates of the stacked ESD of the invention. For example, the stacked ESD of the invention may be formed by stacking electrode units having substrates with cross-sectional areas that are rectangular, triangular, hexagonal, or any other desired shape or combination thereof.

It will be understood that the foregoing is only illustrative of the principles of the invention, and that various modifications may be made by those skilled in the art without departing from the scope and spirit of the invention. It will also be understood that various directional and orientational terms such as “horizontal” and “vertical,” “top” and “bottom” and “side,” “length” and “width” and “height” and “thickness,” “inner” and “outer,” “internal” and “external,” and the like are used herein only for convenience, and that no fixed or absolute directional or orientational limitations are intended by the use of these words. For example, the devices of this invention, as well as their individual components, may have any desired orientation. If reoriented, different directional or orientational terms may need to be used in their description, but that will not alter their fundamental nature as within the scope and spirit of this invention. Those skilled in the art will appreciate that the invention may be practiced by other than the described embodiments, which are presented for purposes of illustration rather than of limitation, and the invention is limited only by the claims that follow.

What is claimed is:

1. An energy storage device comprising:
a stack of a plurality of electrode units, the stack comprising:
a first sub-stack of a plurality of bi-polar electrode units;
a second sub-stack of a plurality of bi-polar electrode units collinear with the first stack; and
a mono-polar electrode unit positioned between the first sub-stack and the second sub-stack;
a first end cap at a first end of the stack of electrode units; and
a second end cap at a second end of the stack of electrode units.

2. The energy storage device of claim 1 wherein the mono-polar electrode unit is configured to electrically couple the first sub-stack in parallel with the second sub-stack.

3. The energy storage device of claim 1 wherein the polarity of the mono-polar electrode unit is opposite the polarity of the first and second end caps.

4. The energy storage device of claim 1 wherein the electrode units of the first sub-stack and the electrode units of the second sub-stack have separate chemistries.

5. The energy storage device of claim 4 wherein the electrode units of first sub-stack are lithium-ion and the electrode units of the second sub-stack are lead-acid.

6. The energy storage device of claim 1 wherein the bi-polar electrode units of the first sub-stack are electrically coupled in series.

7. The energy storage device of claim 1 wherein the bi-polar electrode units of the second sub-stack are electrically coupled in series.

8. The energy storage device of claim 1 wherein the first sub-stack and the second sub-stack are electrically coupled in series.

9. The energy storage device of claim 1 wherein each bi-polar electrode unit comprises:
a conductive substrate;
a positive active material electrode layer on a first surface of the conductive substrate; and
a negative active material electrode layer on a second surface of the conductive substrate.

10. The energy storage device of claim 1 wherein the mono-polar electrode unit comprises:
an impermeable substrate;
a first active material electrode layer on a first surface of the non-conductive substrate;
a second active material electrode layer on a second surface of the non-conductive substrate, wherein the first layer and the second layer have the same polarity.

11. The energy storage device of claim 10 wherein the impermeable substrate is conductive.

12. The energy storage device of claim 10 wherein the impermeable substrate is non-conductive.

13. The energy storage device of claim 1 wherein an electrolyte layer is provided between each pair of adjacent electrode units.

14. The energy storage device of claim 1 wherein the first and second sub-stacks have the same number of bi-polar electrode units.

15. The energy storage device of claim 14 wherein the mono-polar unit is placed centrally within the stack between the first and second sub-stacks.

16. The energy storage device of claim 1 wherein the first and second sub-stacks do not have the same number of bi-polar electrode units.

17. The energy storage device of claim 1 further comprising:
a third sub-stack of a plurality of bi-polar electrode units, wherein the third sub-stack is placed between the second sub-stack and the second end cap; and
a second mono-polar unit positioned between the second sub-stack and the second end cap, wherein the second mono-polar electrode unit is configured to electrically couple the first, second, and third sub-stacks in parallel with one another.

18. The energy storage device of claim 1, further comprising:
a third sub-stack of a plurality of capacitors, wherein the third sub-stack is placed between the second sub-stack and the second end cap; and
a second mono-polar unit positioned between the second sub-stack and the second end cap, wherein the second mono-polar electrode unit is configured to electrically couple the first, second, and third sub-stacks in parallel with one another.

19. The energy storage device of claim 18 wherein the capacitors have a double layer electrode configuration.

20. The energy storage device of claim 18 wherein the voltage of the third sub-stack is equal to or greater than the voltage of the energy storage device.

21. An energy storage device comprising:
a stack of a plurality of electrode units along a stacking axis, the stack comprising:
a mono-polar electrode unit having a first and second surface on opposite sides thereof;
a first bi-polar electrode unit provided along the stacking axis opposite the first surface;
a second bi-polar electrode unit provided along the stacking axis opposite the second surface, wherein the first and second bi-polar electrode units are electrically coupled in parallel via the mono-polar electrode unit.

22. The energy storage device of claim 21 further comprising a single pair of end caps provided at opposite ends of the stack.

23. The energy storage device of claim 21 wherein the mono-polar electrode unit has a positive or negative polarity.

24. The energy storage device of claim 21 wherein an electrolyte layer is provided between each pair of adjacent electrode units.
